(19) United States
(12) Patent Application Publication
(10) Pub. No.: US 2004/0208595 A1
(43) Pub. Date: Oct. 21, 2004

(54) Free space communication system with common optics and fast, adaptive tracking

(76) Inventors: Fai Mok, Pasadena, CA (US); James Kent Wallace, Pasadena, CA (US)

Correspondence Address: John E. Wagner, Esq., LAW OFFICES OF JOHN E. WAGNER, 2541 Ocean View Boulevard, Glendale, CA, 91208, US

(21) Appl. No.: 10/154,010

(22) Filed: May 21, 2002

Related U.S. Application Data
(60) Provisional application No. 60/358,433, filed on Feb. 19, 2002.

(51) Int. Cl. H04B 10/00

(52) U.S. Cl. 398/128

(57) ABSTRACT

A free space optical data communications system, including transceiver nodes employing common optics in both the transmit and receive subsystem, is disclosed. Likewise, a beacon is disclosed utilizing some of the common optics as well. In one embodiment, a double-faced mirror cooperates with a beacon, a primary mirror, and the transmit and receive subsystems. In one other embodiment, the beacon is located in front of the primary mirror. In still another embodiment, the common optics includes TEM11 mode signal separation using phase plates. A tracking system in each embodiment maintains alignment of the optics with a second node by generating a correction vector responsive to the incoming signal from its companion node.

### REFERENCE TO RELATED PATENT APPLICATION

This non-provisional application claims benefit of U.S. provisional patent application Serial No. 60/358,433, filed Feb. 19, 2002, and hereby claims the benefit of the embodiments therein and of the filing date thereof.

### BACKGROUND OF THE INVENTION

In a free space optical communication link, two (or more) transceivers that must communicate with one another must be carefully aligned to establish and maintain a high link margin (low loss) and ultimately a high quality of service. Positional and angular errors due to, but not limited to, relative platform movement and optical path aberrations must be accurately tracked and compensated to maintain a high link margin.

The current state of the art suffers from the need for a complex multi-axis optical system involving large mass optics, which in turn require expensive actuators to move in response to alignment errors and link aberrations. An automatic alignment system is essential not only to the successful operation of a free space link but ultimately will dictate the cost effectiveness of the approach.

Typical single axis systems usually employ the use of separate transmit and received optics, side by side, and do not achieve any common usage of the major optical elements in both subsystems with resulting economy. Boresight scopes are often used as the alignment devices at each node and rely upon the transmitted beam spread to achieve transmission reliability.

Examples of the prior art may be seen in the following United States patents:

| | | |
|---|---|---|
| 3,705,986 | R. W. Sander et al | Dec. 12, 1972 |
| 4,330,870 | T. C. Arends | May 18, 1982 |
| 4,941,205 | W. R. Horst et al | Jul. 10, 1990 |
| and | | |
| 6,285,476 B1 | R. T. Carlson et al | Sep. 4, 2001. |

Examples of duplicate optical systems in the transmit and receive channels of one node are illustrated in the Sanders et al. U.S. Pat. No. 3,705,986 and the Arends U.S. Pat. No. 4,330,870, as well as U.S. Pat. No. 4,941,205 to Horst et al.

In U.S. Pat. No. 6,285,476 B1 to Carlson et al., a boresight is used and the transmit and receive optics share a common housing, heated window and a dichroic beam splitter.

### BRIEF DESCRIPTION OF THE INVENTION

Given this state of the art, we have conceived and demonstrated a node or transceiver for free space optical data which combines several advances in the state of the art.

First, it simplifies and reduces the cost of the transceiver through the common use of optics in the transmit branch, the receive branch, and the beacon or alignment correction subsystem.

Second, we have developed a system in which common optics includes a double-faced mirror and a primary mirror within the system housing, which cooperate to transmit a beacon alignment signal reflected off of one face of the planar mirror, and on the other face thereof reflects both transmitted and received optical data signals which are reflected by the primary mirror.

Third, in this preferred system, alignment is maintained with its corresponding node by movement of a lens which is common to both transmitted and received data and received beacon signals for its corresponding node.

Fourth, transmit and received data signals are separated in a duplexer which comprises simple single mode and multimode optical fibers.

Fifth, all the optical elements are within or secured to the enclosure whereby primary alignment using a borescope brings the transmit, receive and beacon optics into rough alignment in one step.

In another embodiment, the beacon is located within the enclosure in front of the primary mirror on its optical axis where it does not interfere with either transmit or received signals, and a single faced mirror reflects signals into and out of the enclosure to a cold mirror for reflecting beacon signals for alignment correction if needed and allows received and transmitted data signals to pass. A beamsplitter of either a polarizing or nonpolarizing type separates the received and transmitted signal paths. A tracking system, which is driven by beam correction vector signals, is included.

In still another embodiment, the common optics include a single faced mirror with a pinhole aperture collimating lens and a pair of phase plates to selectively pass received and transmitted optical signals. In this embodiment virtually all optical elements of both the transmit and receive channels have common optics.

These inventions, enumerated above, may be applied to any free space optical (FSO) link between two nodes is shown schematically in FIG. 1 below. Each node A and node B consists of:

a) front end optics assembly;

b) a tracking system to maintain alignment;

c) a pair of optical transceivers to interface between the FSO node and the communications network served.

Given that transceivers are often commoditized off-the-shelf products at the data rates required for FSO (maximum of 2.5 Gbps, circa 2002), the first two subsystem elements, the front-end optics and the tracking system, are the most important and will set the basis of the FSO product selection.

### BRIEF DESCRIPTION OF THE DRAWING

This invention may be more clearly understood from the following detailed description and by reference to the drawing in which:

FIG. 1 is a simplified block diagram of a free space optical data transmission system with one node A shown enlarged with each of its basic subsystems shown in block form;

FIG. 2 is a simplified block diagram and longitudinal sectional diagram of one embodiment of a node in accordance with this invention;

FIG. 3 is a side elevational view of a simple fiber optics duplexer;

FIG. 4 is a side elevational view of a coated fiber optics duplexer;

FIG. 5 is a block diagram of a breadboard embodiment of this invention with the optical beacon and transmitter/receiver portion shown in longitudinal sectional form;

FIG. 6 is a simplified optical diagram of another embodiment of this invention; and

FIG. 7 is a block diagram of the training system of this invention.

### DETAILED DESCRIPTION

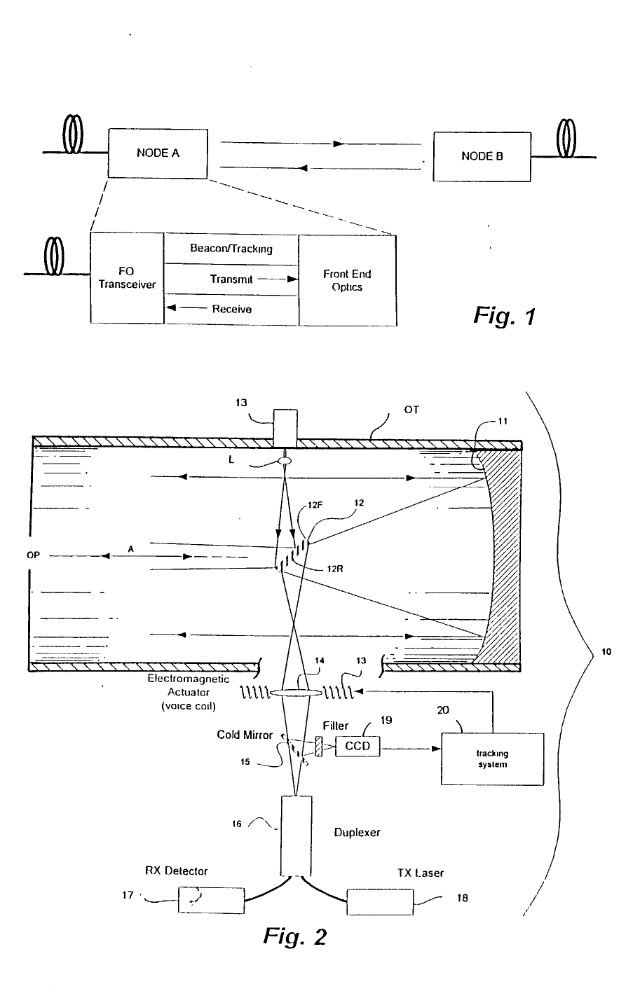

The dominant source of link impairment problem in free space communication systems is alignment errors. As indicated in FIG. 1, the transmitted beam from one node must be pointed correctly at the other node (relative angular alignment); and the receiving node, in turn, must be aligned with the transmitting node to maximize the received signal. Each node transmits a divergent beacon beam that is used by the other node to acquire the signal and uses the beacon to track the transmitted beam. Our invention, as illustrated in FIG. 2, has the following key features:

1) The use of some common optics for the beacon transmit and receive beams, vastly simplifying the optics, which in turn reduces assembly, component costs as well as simplifying the tracking requirements (i.e., concerned with aligning a single axis as opposed to multiple axes).

2) Only a single optical element, namely, the beacon assembly fixed within an optics tube, needs to be adjusted either in two angular coordinates or the transverse positional coordinates.

3) The servo system required for tracking is locally controlled in each node (i.e., the error signal is derived locally in contrast with other methods where the positional and angular errors of the transmitting node are also used in current systems which are prone to control instabilities).

FIG. 2 illustrates a free space optical communications node generally designated 10 with a transmit/receive axis A, defined by node optics tube OT supporting primary mirror 11. A small 45-degree, double-faced mirror 12 is located on the optical axis A between the primary mirror 11 and the exit opening OP of the node 10. A beacon laser 13 is directed via an opening in the tube OT and a convex lens L at the front (facing OP) face 12F of mirror 12, which reflects the beacon beam out of the opening OP along axis A for detection at the matching node for node alignment.

Transmitted and received optically encoded data at opening OP and the beacon signal from the remote node are reflected by the primary mirror 11, and the rear reflective face 12R of mirror 12 out of the tube OT through a side wall opening. Data signals are reflected 90-degrees from axis A by mirror 12 surface 12R to or from a lens 14 mounted on a voice coil actuator 13. The lens 14 focuses received data signals which pass through cold mirror 15 on the end of duplexer 16 for reception and detection by RX detector 17. Transmitted optical data stream from transmitter TX 18 passing through duplexer 16, cold mirror 15, and lens 14 enters the optical tube OT, is reflected by surface 12R of mirror 12 to the primary mirror 11 and out of tube OT through the opening OP.

Received beacon signals from the opposite node after reflection by primary mirror 11 and surface 12R of 45-degree oriented mirror 12 exiting the side opening of tube OT with received data signals are reflected by cold mirror 15 through a filter 18 to a CCD display 19. Off center images of the received beacon signal at the CCD display 19 are used by tracking system 20 to feed back alignment correction signals to the voice coil actuator 13 for optimum X Y repositioning of lens 14 and optimum signal strength. The tracking system 20 of FIG. 2 is shown and described below in connection with FIG. 5.

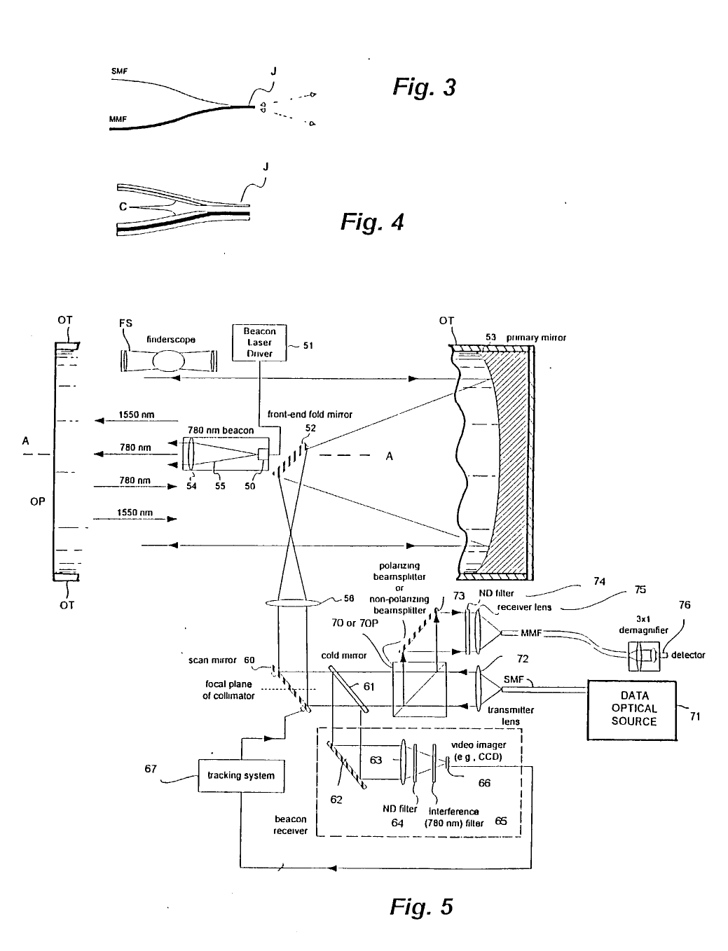

The preferred form of duplexer 16 of FIG. 2 is illustrated in FIGS. 3 and 4 produced by co-positioning a single mode fiber SMF with a multimode fiber MMF at a joining point J in FIG. 3 and suitably removing any protective or reflective coating C of FIG. 4 grinding, polishing, and fusing the fibers together to form a junction.

Although different realizations of our invention are possible, we describe a particularly simple implementation that does not rely on polarization or wavelength diversity techniques to duplex the transmit and the receive beam. A more straightforward implementation that has been demonstrated in the laboratory is described by the following description of a breadboard Installation identified here as FIG. 5.

The FIG. 5 breadboard system describes a common axis system that has been assembled and demonstrated. In this embodiment, a 780 nm beacon 50 that is used by each node to mutually acquire and track are arranged to function in the same way as the system described in the above system disclosure of FIG. 1. The beacon 50, powered by an external driver 51, is located coaxially with the transmit/receive axis A in front of a front-end, 45-degree fold mirror 52, and in front of the concave primary beam forming mirror 53 which is enclosed along with the beacon 50 in an optics tube OT. A finder scope FS, extending parallel to tube OT, provides rough alignment of the nodes.

The beacon 50 is preferably a laser with its collimating lens 54 in a small diameter, e.g., tube 55 positioned on axis A. The wavelength of the laser is chosen so that an inexpensive imaging device, such as silicon CCD arrays, can be used to sense the beacon light efficiently. For example, to operate with silicon CCD arrays, the laser wavelength is best chosen to be shorter than 800 nm. The beacon assembly 50, 54, and 55 on axis A operating at 780 nm is sufficiently small in diameter, as compared with the primary mirror 53, so as to not interfere with the data communication at 1550 nm, for example.

The common optics for the transmit and receive communications data begins with the primary mirror 53, which focuses received signals on the rear facing front end fold mirror 52 and receives transmitted data signals for the mirror 52 for reflection and transmission of a slightly spread beam to the remote receiving node, which duplicates the system of FIG. 5.

The received beacon and data signals at mirror 52 are reflected at 90-degrees from the axis A to a collimating lens 56 and a 45-degree oriented scan mirror 60.

The only material difference between the breadboard system of FIG. 5 and the more general system in the disclosure is the duplexing method used to separate the transmit from the receive beam in the common axis architecture. In the breadboard system of FIG. 5, the transmit beam and the receive beams are brought together to a common axis by the use of either a polarization beamsplitter or a common non-polarization selective beamsplitter 70 after reflection by the scan mirror 60 and direct passage through cold mirror 61 as shown in the breadboard embodiment of FIG. 5.

In the case of a non-polarization selective beamsplitter 70, ½ of the transmitted light is lost, and likewise 1/2 of the received light is lost. In the case of a polarizing beamsplitter 70P, each node must set up properly to send the correct polarization in the transmitted beam, which will pass through the polarizing beamsplitter 70P in the receiving node with maximum efficiency. In this way, the theoretical efficiency can approach 100%.

So, in the polarizing scenario, the position of the transmitting source and the receiving detector are switched between the two nodes, with respect to the polarizing beamsplitter. In the FIG. 5 breadboard, the single mode fiber SMF optically encoded data from brings the transmitting source via the transmitting lens 72 to the beamsplitter 70P with a polarization state that is parallel to the plane of the paper. Transmitted data passes through the polarized beam splitter 70P, through cold mirror, is reflected by the scan mirror 60, through lens 56, is reflected off the front end fold mirror 52 to the primary mirror 53 and reflected out of the opening OP via free space to the mating node.

Received data reverses the path of the transmitted data, via mirror 53, fold mirror 52, lens 56, scan mirror 60, cold mirror 61 until it reaches the beamsplitter 70 or 70P, where it is reflected to 45-degree mirror 73, ND filter 74, receiver lens 75 to the input end of a multi mode fiber MMF to a 3×1 demagnifier, and then to detector 76. The received beam, therefore, must have the orthogonal polarization (i.e., perpendicular to the plane of the paper). The relative positions of the transmit and receive optics are switched in the other node.

The cold mirror 61 reflects and couples the received beacon light out of the common optical system onto a 45-degree mirror 62, focusing lens 63, ND filter 64, interference (780 nm) filter 65, an imaging CCD 66 for acquisition and tracking purposes.

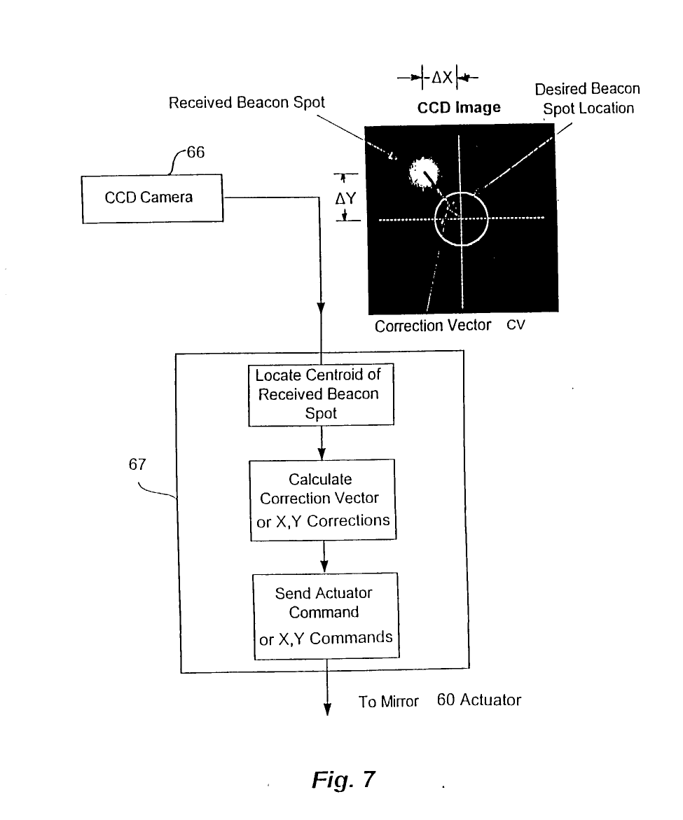

A tracking system similar to that disclosed in FIG. 7 below is employed. The original disclosure of FIGS. 1 and 2, and demonstrated in the breadboard of FIG. 5 describes a particular method of duplexing the transmit and receive beams using a fiber coupler with single mode fiber (SMF) and multimode fiber (MMF) ports. Here, a simpler technique is described that relies on bulk optical elements that are more easily fabricated and hence lower cost in nature.

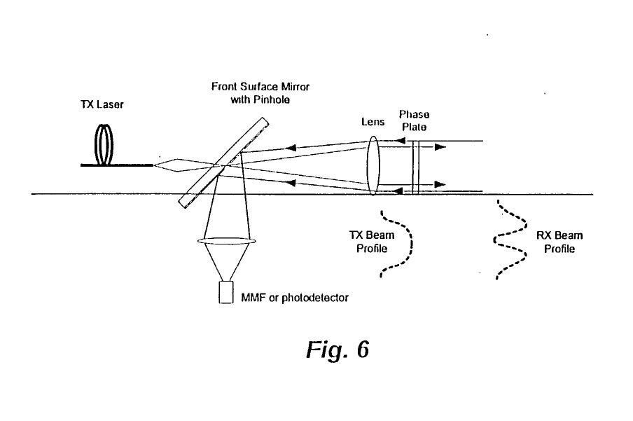

The key to the system operation, as illustrated in FIG. 6, in the desired common-optics mode is to effectively couple the receive beam out of the common optical path without adversely affecting the transmit beam. This can be accomplished by requiring the transmit beam to have a null in the center of the beam in the far field. In gaussian optics terms, this means that the fundamental gaussian mode from the laser is converted into the TEM11 mode which is the lowest order doughnut mode. The far field divergence can be made approximately the same as the fundamental mode provided that a properly designed phase plate is used to perform the mode conversion.

The new idea is described in FIG. 6, which shows the transmit laser source 100 as a point source behind a mirror 101 oriented at 45-degrees from the optical axis. The laser source 100 is focused through a small hole 102 at the center of the mirror to pass through and is collimated by a lens 103. A phase plate 104 shapes the far field intensity profile of the beam into the desired TEM11 mode. The receiving node has the identical system so that the received beam is focused onto the mirror 101 plane. Because of the TEM11 mode, however, the focused distribution has a null in the center so most of the light is reflected out of the common path by the mirror 101 which can further be focused by lens 106 onto the desired photodetector or MMF 107.

The phase plates, such as plates 104 and 105, can be designed by known computer generated hologram or optical element approaches and the preferred solution is to have either as an etched glass plate or embossed plastic plate to yield the desired phase pattern across the aperture. Since there are two such phase plates, the design procedure should take this constraint into account. Again, this is a straightforward design procedure but the overall concept of this embodiment is novel.

Tracking Subsystem Description

The tracking subsystem 67 of FIGS. 2, 5, 6, and 7 analyzes the sequence of images from the CCD imager 66 to assess the current position of the other node's beacon spot and send a suitable command to the movable lens (or mirror in a different but functionally equivalent realization as described in the breadboard description of FIG. 5) to re-align the common axis optical system.

As shown in FIG. 7, the image from the CCD is evaluated frame-by-frame (in he video sequence). A typical image frame is shown in FIG. 7 where the apparently misaligned beacon spot is shown off-center in the upper left quadrant with respect to the target defined by the origin, the intersection of the two X and Y axes. The angular position error is denoted by the length and direction of the correction vector CV and also by the orthogonal errors ΔY and −ΔX.

As shown in FIG. 7, the desired correction vector CV is that which connects the axes center or origin and the centroid of the beacon spot. The centroid calculation can use standard curve fitting algorithms which uses the intensity distribution of the spot to yield a robust estimate of the spot position. The tracking subsystem then computes the necessary correction vector or ΔX and ΔY corrections mapped to the coordinate frame of the adjustable lens 14 of FIG. 2 or mirror 60 of FIG. 5, which is sent to the lens or mirror actuator as an alignment correction command.

Altogether these embodiments show several free space communication systems employing common optics and tracking control of each node independent of the matching node.

The above-described embodiments of the present invention are merely descriptive of its principles and are not to be considered limiting. The scope of the present invention instead shall be determined from the scope of the following claims including their equivalents.

We claim:

1. A transceiver node in a free space optical data communications systems comprising:
an optics enclosure having a longitudinal axis and an opening for the transmission and reception of optically encoded data generally along the axis;
a primary mirror facing said opening for reflecting incoming and outgoing optically encoded data;
a double-faced mirror including first and second reflective surfaces positioned within said optics enclosure and generally at a 45-degree angle with the axis of said enclosure;
a beacon positioned to introduce a beacon signal into said optics enclosure directed at the first face of said double-faced mirror for reflection out of said optics enclosure through the opening therein generally along the axis of said optics enclosure;
optical data handling means directed at the second face of said double-faced mirror for receiving optically encoded data arriving at said primary mirror and reflected by said double-faced mirror out of said optics enclosure and for transmitting optically encoded data;
whereby directing the axis said optics enclosure at a similar node allows data transmission, node alignment tracking, and reception of optically encoded data is accomplished employing common optics in node tracking, transmission, and reception of data.

2. A transceiver node in accordance with claim 1 wherein said beacon signal source is a laser.

3. A transceiver node in accordance with claim 1 wherein said primary mirror is a concave and focuses incoming optical data signals on the second reflective surface of said double-faced mirror.

4. A transceiver node in accordance with claim 1 wherein the double-faced mirror is positioned substantially on the axis of said optical enclosure.

5. A transceiver node in accordance with claim 1 wherein said optical data handling means includes lens means directed at the second face of said double-faced mirror for focusing received incoming data.

6. A transceiver node in accordance with claim 5 including a transmit data signal source and a duplexer for duplexing incoming and transmitted optically encoded data at said lens means.

7. A transceiver node in accordance with claim 5 including means for selectively positioning said lens means.

8. A transceiver node in accordance with claim 7 including means for producing an image of incoming optical signals and means for moving said lens means to an optimum position dependent upon the position on said image of incoming signals.

9. A transceiver node in accordance with claim 8 wherein said means for producing an image of incoming data includes a cold mirror positioned in the optical path of said lens means.

10. A transceiver node in accordance with claim 8 wherein said means for producing an image of incoming data includes a CCD device.

11. A transceiver node in accordance with claim 7 wherein said means for moving said lens means includes a tracking system for calculating a correction vector of the image of received optical data signals and for introducing that correction into said moving means.

12. A transceiver node in accordance with claim 1 wherein said optical data source and at least a portion of said optical data receiver are coupled to move with said optics enclosure.

13. A transceiver node in accordance with claim 6 wherein said duplexer comprises at least one co-joined single mode and a single multimode fiber.

14. A transceiver node for a free space optical communications system comprising:
an optics body open at one end and defining an optical axis for the node;
a beacon positioned in said body generally on the axis of said optics body for radiation of a beacon signal out of said body generally along the axis thereof;
an optical signal receiver;
an optical signal transmitter;
a primary mirror positioned in said body remote from the opening in said body for reflection received and transmitted optical data through said opening generally along the axis of said body;
a second mirror positioned in said body generally on the axis of said body and at a 45-degree angle facing said primary mirror for reflecting transmitted and received optical signals passing through the opening in said enclosure toward said optical signal transmitter and receiver, respectively; and
common optical elements for transmitted and received optical signals are reflected by said second mirror comprising a collimating lens, a movable scan mirror and a beam splitter.

15. A transceiver node in accordance with claim 14 wherein said beam splitter is a polarizing beam splitter.

16. A transceiver node in accordance with claim 14 wherein said beacon operates at a frequency different than the transmitted and received frequencies.

17. A transceiver node in accordance with claim 16 wherein said beacon operates in the region of 780 nm. while optical data signals operate in the 1550 nm. range.

18. A transceiver node in accordance with claim 14 including a beacon receiver for detecting signals in the beacon range.

19. A transceiver node in accordance with claim 18 including optical means for extracting beacon frequency content from received optical signals.

20. A transceiver node in accordance with claim 14 including tracking means for controlling the position of said movable scan mirror responsive to a beacon signal received.

21. An optical data transceiver for transmitting and receiving optically encoded data comprising:
an optical data transmit source for producing an optical data beam;
a received optical data detector;
lens means for collimating transmitted optical data beam;
optical means for combining transmitted and received optical data beams into a common path;
selective optics transmissive means for allowing the transmission of optical signals in the transmission direction while suppressing transmission in the opposite direction; and
selective optical transmission means for allowing the passage of optical signals in the received direction while suppressing the transmission in the transmitting direction;
whereby transmitted and received optical signals employ common optical elements.

22. An optical data transceiver as claimed in claim 21 wherein said selective optical transmission means comprise phase plates.

23. An optical data transceiver as claimed in claim 22 wherein said phase plates have far field interset profiles in a TEM II mode.

24. An optical data transceiver as claimed in claim 21 wherein said optical means for combining optical data beams comprise an apertured mirror oriented at a generally 45-degree angle with respect to the direction of transmission and receipt of optical signals.

25. An optical data transceiver as claimed in claim 24 wherein said optical data transmit source is positioned to transmit through the aperture of said apertured mirror.

26. An optical data transceiver as claimed in claim 24 wherein said optical data receiver is positioned to receive optical data reflected off of said apertured mirror.

27. An optical data transceiver as claimed in claim 24 wherein the aperture of said apertured mirror is a pinhole.
